(19) United States
(12) Patent Application Publication
(10) Pub. No.: US 2005/0063001 A1
(43) Pub. Date: Mar. 24, 2005

(54) Printing system and printing control method

(75) Inventor: Akihito Tanimoto, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/733,812

(22) Filed: Dec. 12, 2003

(30) Foreign Application Priority Data
Dec. 13, 2002 (JP) 2002-363109

(51) Int. Cl. G06F 3/12; G06F 13/00; G06F 12/16

(52) U.S. Cl. 358/1.15; 358/1.16; 710/56

(57) ABSTRACT

A system is provided for enabling the efficient reuse of printing data stored in a printer to execute printing without retransmission of printing data. The system comprises data management means, which, when a printing request received from a client device is of a type involving the transmission and reception of printing data, stores the printing data received from the client device in storage means in association with management information, and transmits the management information to the client device; means which, when the printing request is of a type involving the transmission and reception of management information associated by the data management means, references the above storage means and reads out the printing data associated with the management data received from the client device; and means to execute printing based on the printing data. When the data management means judges it necessary to delete printing data from the above storage means, printing data is selected and deleted based on priority information relating to data deletion.

### BACKGROUND

This invention relates to technology used to perform printing (image formation) based on printing data transmitted from a client device to a printer or similar.

In the prior art, when performing printing via a printing control terminal, the device requesting printing (the client device) first transmits printing data to the printing control terminal, and at the printing control terminal the received printing data is stored in a spool file of a general-purpose operating system. Then, the printing control terminal normally outputs to the printer the printing data stored in the spool file, and performs printing control (see Japanese Patent Laid-open No 8-30413).

On the other hand, there are also printers comprising functions to directly exchange printing data with a digital camera or other client device, without an intervening printing control terminal, and to perform printing. In recent years, with the spread of Bluetooth and other wireless technologies, printers have also been developed comprising functions to receive printing data by wireless means from a client device and to perform printing.

### SUMMARY

Normally in a printer, the received printing data (image data or similar) is deleted from the printer memory after printing is completed, and when the same content is to be printed again, it is necessary to once again transmit the printing data to the printer.

However, in such a configuration entailing retransmission of printing data, each time printing is performed, power required for data transmission is consumed on the transmitting side, and for example in the case of a digital camera or other rechargeable-type device, this may be a factor hindering operation over an extended length of time. Moreover, using the above configuration, time is required for data transmission each time printing is performed, so that there is the problem that rapid printing is difficult.

Hence a first object of this invention is to provide a framework enabling execution of printing without retransmission of printing data from the transmission side.

The inventors came to think that the above first object can be achieved by adopting a framework in which management information is allocated to and stored with printing data received by the printer, and the management information rather than the printing data is received from the transmitting side when printing is to be performed again.

In this case, when the memory in the printer storing the printing data becomes full, a portion of the printing data already accumulated must be deleted in order to secure free memory for storage of new printing data.

However, if a configuration is adopted in which stored printing data is simply deleted without providing some standard, printing data with a high probability of being printed again may be deleted, and so even in the above-described framework there will frequently occur situations in which retransmission is necessary. Further, if printing data with a large data size is deleted, when the need for reprinting arises time is required for the data transmission, and there is the problem that a longer amount of time elapses until the end of printing.

Hence a second object of this invention is to provide a framework enabling the efficient reuse of printing data to execute printing.

In order to achieve the above objects, a printing control method of this invention comprises: a data management step of storing printing data received from a client device, in storage means in association with management information, and of transmitting the management information to the client device when a printing request received from the client device is a printing request of a type involving the transmission and reception of printing data; a step of referencing the storage means and of reading out printing data associated with management information received from the client device when the printing request is of a type involving the transmission and reception of management information associated with the printing data in the data management step; and a step of executing printing based on the received printing data or on the read-out printing data.

It is preferable that, when it is judged necessary to delete printing data from the above storage means, the above data management step selects and deletes printing data based on priority information relating to data deletion.

By means of this configuration, printing data can be efficiently reused based on priority information to execute printing.

It is preferable that the above data management step references rule storage means which stores at least one setting rule for the above priority information, to set the above priority information.

It is preferable that the above rule storage means comprise a step of registering setting rules based on input from the user.

It is preferable that the above setting rules be composed based on at least one among the time of storage, time of use, frequency of use, and data size of the printing data.

By means of this configuration, various setting rules can be registered, and the order of deletion of printing data can be flexibly controlled. Further, the frequency of occurrence of retransmission can be reduced, and even in cases when retransmission must be performed, a lowering of printing throughput can be suppressed, and printing processing can be executed efficiently.

In order to achieve the above objects, a printing system of this invention comprises data management means for storing printing data received from a client device in storage means in association with management information, and for transmitting management information to the client device when a printing request received from the client device is a printing request of a type involving the transmission and reception of printing data; means for referencing the storage means and for reading out printing data associated with management information received from the client device when the printing request is of a type involving the transmission and reception of management information associated with the printing data by the data management means; and means for executing printing based on the received printing data or on said read-out printing data.

Also, a printing system of this invention is a printing system comprising at least one client device and a printing device configured to enable communication with said client device, wherein the client device can output two types of printing requests, consisting of a first type involving the transmission and reception of printing data and a second type involving the transmission and reception of management information associated with printing data by the printing device, and wherein the printing device, upon receiving the first type of printing request from a client device, stores printing data received from the client device in association with management information in storage means, transmits the management information to the client device, and executes printing based on the printing data; whereas, upon receiving the second type of printing request from a client device, references the storage means, reads out printing data associated with management information received from the client device, and executes printing based on the read-out printing data.

By means of this configuration, when printing data stored in the above storage means there is no need to transmit the printing data from the client device, so that the power consumption involved in transmission of the printing data is saved and the time of operation of a rechargeable device can be extended, while the time required for data transmission can be shortened and printing can be executed efficiently.

Each of the steps of a printing control method of this invention can be executed by a computer. In this case, the program can be installed onto or loaded into the computer through a CD-ROM, magnetic disk, semiconductor memory, or various other recording media, or via a communication network.

In this specification, “means” does not merely signify physical means, but also includes cases in which the function of the “means” is realized through software. Also, a function of one “means” may be realized through two or more physical means, and a function of two or more “means” may be realized through one physical means.

### DESCRIPTION OF DRAWINGS

FIG. 1 is a block diagram showing the hardware configuration of a first aspect;

FIG. 2 is a block diagram showing the functional configuration of the information processing portion in the first aspect;

FIG. 3 is a conceptual diagram showing the data structure of the management data storage means 30;

FIG. 4 is a drawing used to explain setting rules for deletion priority information;

FIG. 5 is a flowchart showing the operation of the printing control means 20; and,

FIG. 6 is a flowchart showing the operation of the printing control means 20.

### DETAILED DESCRIPTION

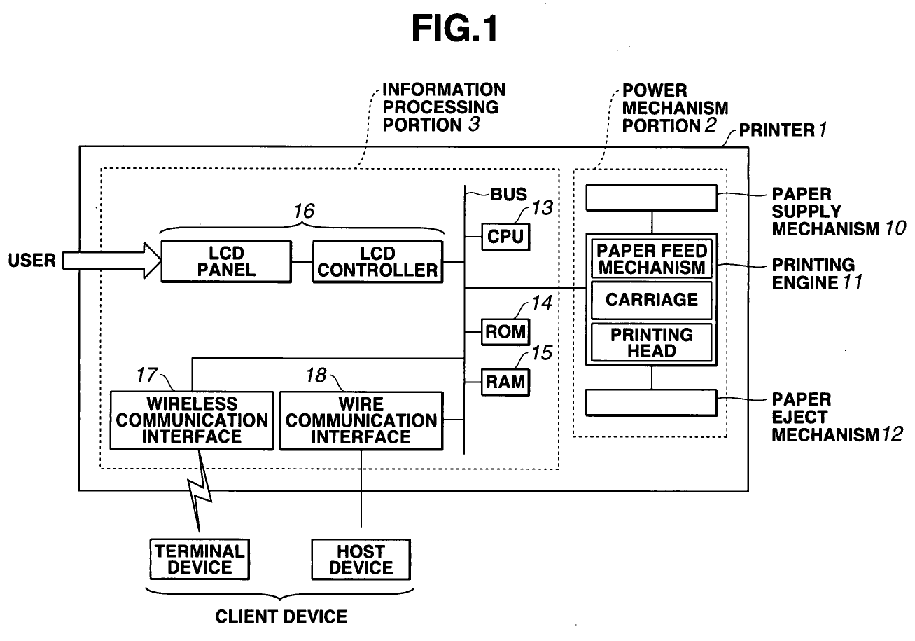

The first aspect of this invention is explained referring to the drawings. FIG. 1 is a block diagram showing the hardware configuration of a printer 1 of this aspect.

The printer 1 comprises a power mechanism portion 2, in turn comprising a paper supply mechanism 10 which supplies paper sheets to the printer, a printing engine 11 which performs printing, and a paper eject mechanism 12 which ejects sheets of paper from the printer. The printing engine 11 comprises a paper feed mechanism, carriage mechanism, and printing head.

As the printing engine 11, a serial printer such as an inkjet printer or thermal transfer printer which prints in one-character units, a line printer which prints in line units, or various other printing engines can be used.

This power mechanism portion 2 is controlled and made to perform printing operations by an information processing portion 3, comprising a CPU (processor) 13, ROM 14, RAM 15, LCD panel and LCD controller 16, wireless communication interface (Bluetooth interface or similar) 17, and wire communication interface 18. The CPU 13 can access the several means 14 through 18 via an bus, and controls and causes actual printing to be performed by the power mechanism portion 2 according to printing data (for example, JPEG format compressed image data) sent, via the wireless communication interface 17 and/or wire communication interface 18, from a digital camera or other terminal device or from a personal computer or other host device (including printing control terminals) (hereafter, the device which transmits printing data to the printer 1 is called the “client device”). The power mechanism portion 2 may independently comprise a CPU; in this case, the CPU of the power mechanism portion 2 communicates with the CPU 13 via a parallel interface or similar, and controls and causes printing operation by the printing engine 11.

The configuration and operation of the power mechanism portion 2 and information processing portion 3 are in essence similar to the configuration and operation of printer devices of the prior art. However, the printer 1 differs from conventional configurations in the fact of comprising a function such that, when a printing request received from a client device is of the type involving the transmission and reception of printing data (transmission by the client device, reception by the printer 1) (hereafter called “the first type”), the printing data received from the above client device is stored in storage means in association with management information, and in addition the management information is transmitted to the above client device, and printing is executed based on the printing data, as well as a function such that, when the above printing request is of the type involving the transmission and reception of management data associated by the data management means (hereafter called “the second type”), the above storage means is referenced, the printing data associated with the management information received from the above client device is read out, and printing is executed based on the read-out printing data.

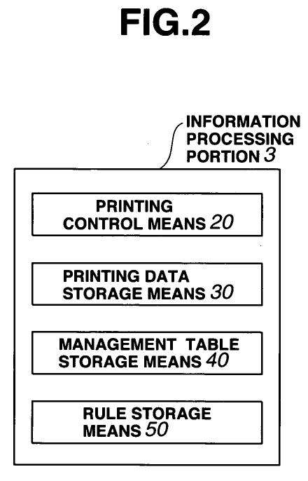

FIG. 2 shows the principal functional configuration of the information processing portion 3. As shown in the figure, the information processing portion 3 comprises printing control means 20, printing data storage means 30, management table storage means 40, and rule storage means 50 and so on.

The printing data storage means 30, management table storage means 40, and rule storage means 50 are realized through use of prescribed regions of the ROM 14 (flash memory or similar) and RAM 15, but may also be realized by using a hard disk or other secondary storage device (including devices under the control of other information processing equipment).

The printing data storage means 30 stores printing data received from a client device. As the data structure of the printing data storage means 30, for example, a ring buffer structure which cyclically stores data can be adopted.

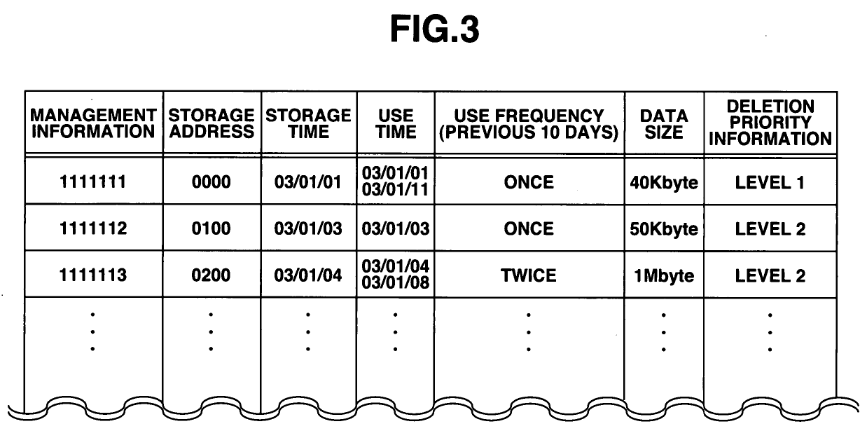

The management table storage means 40 stores a management table, in which are stored, in association with management information, the storage address of the printing data in the printing data storage means 30, the time of storage of the printing data, the time of use (printing time) of the printing data, the frequency of use (frequency of printing), the data size of the printing data, deletion priority information, and similar (see FIG. 3).

Management information is information used to identify printing data. Management information is for example generates within the printer 1 in such a way as not to overlap with previously generated information, and can be allocated at the time printing data is stored. A so-called handle number may be used as management information.

Deletion priority information is information referenced when the printing control means 20 deletes printing data from the printing data storage means 30, and indicates whether data is to be given priority for deletion (or stated conversely, is information indicating whether data is to be given priority for saving). Deletion priority information can for example be expressed on a plurality of levels, and in this aspect is expressed using three levels, from priority level 1 (high priority level; the data for deleting can easily be deleted) to priority level 3 (low priority level; the data cannot easily be deleted).

The rule storage means 50 stores at least one setting rule for deletion priority information.

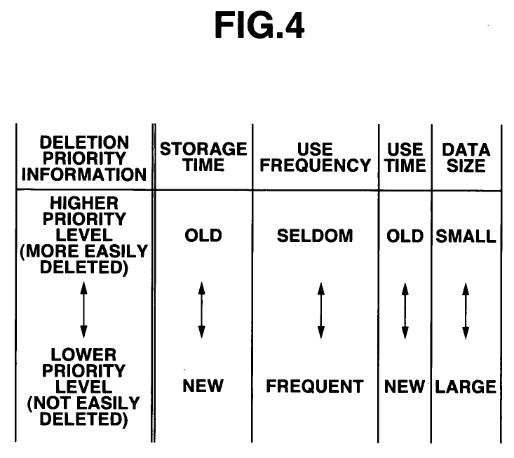

A setting rule can be configured based for example on at least one among the time of storage, the time of use, the frequency of use, and the data size of the printing data, for example to satisfy a relation such as that shown in FIG. 4. In the relation shown in FIG. 4, the newer the time of storage and the time of use, and the higher the frequency of use, and the larger the data size, the lower is the priority level (the harder deletion becomes). This is because it is plausible that the newer the time of storage and time of use, and the higher the frequency of use, the higher will be the possibility of reuse. Also, the greater the data size, the longer the processing time necessary for data transmission, and so the greater is the impact on printing throughput when retransmission is necessary after deletion.

As specific setting rules, for example, “the priority level for printing data which is printed consecutively S or more times is set low,” “the priority level is set according to the number of printing operations in a fixed period of time (for example, within the past T days) (the greater the number of times the printing data is printed, the lower the priority level is set; when computing the number of printing operations, a greater weighting may be applied to printing operations performed more recently),” and “the priority level is set low for printing data the size of which is U or greater” are conceivable.

It is desirable that the rule storage means 50 is configured such that setting rules can be registered by the user. For example, the user can select setting rules to be applied, and where necessary can set the values of the parameters S, T, U and similar in the above examples to register setting rules, either directly via the LCD panel and LCD controller 16, or by transmitting a command to the printer 1 from the client device.

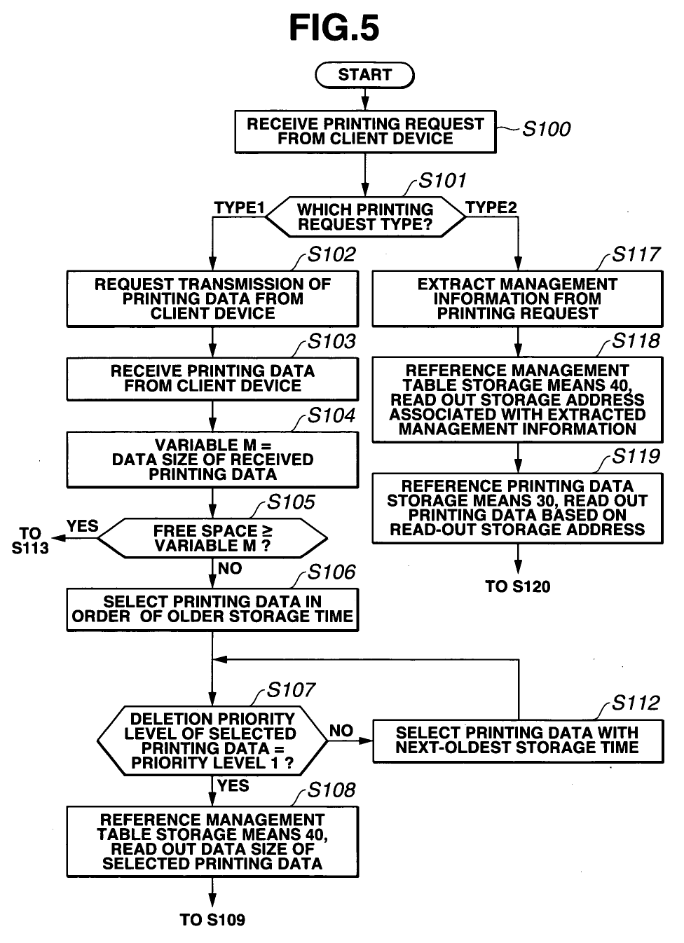

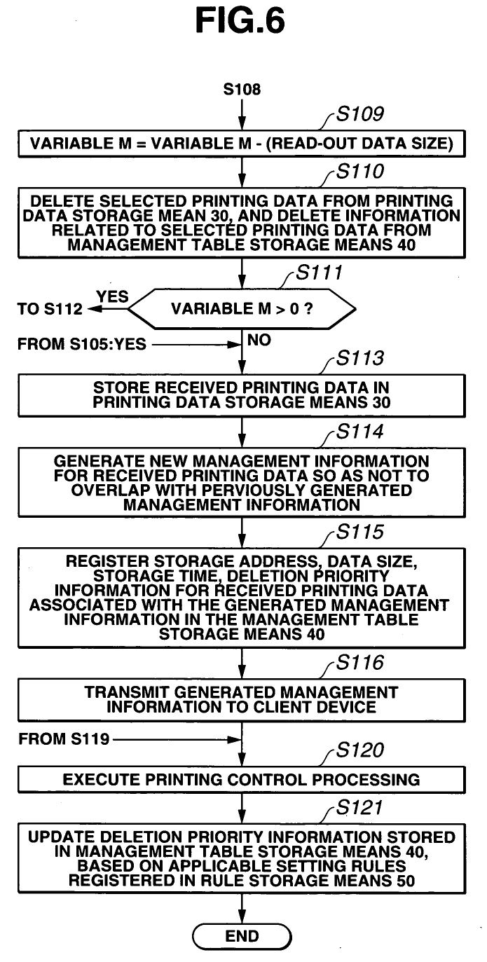

The printing control means 20 is functionally realized by having the CPU 13 execute an application program stored in ROM 14 or RAM 15. Below, the flowcharts shown in FIG. 5 and FIG. 6 are used to explain the operation of the printing control means 20. Each step (including partial steps to which a symbol is not assigned) can be executed with the order changed arbitrarily or in parallel, insofar as no contradictions arise in the content of the processing.

When the client device transmits a printing request to the printer 1, the printing control means 20 receives the printing request via the interface 17 or 18 (S100).

Next, the printing control means 20 judges whether the above received printing request is either the first type or the second type (S101). It is desirable that the client device transmit information to identify the type together with the printing request, in order to facilitate this judgment by the printing control means 20.

When the printing request is judged to be the first type, the printing control means 20 transmits a printing data transmission request to the client device (S102).

Upon receiving this transmission request, the client device transmits the printing data to the printer 1. As a result, the printing control means 20 receives the printing data via the interface 17 or 18 (S103).

Next, the printing control means 20 executes data management processing for the above received printing data (S104 to S116).

First, the printing control means 20 determines the data size of the above received printing data, and substitutes this into the variable M (S104).

Next, the printing control means 20 compares the amount of free space in the printing data storage means 30 with the variable M (S105), and if (free space≧variable M), proceeds to S113.

If on the other hand (free space<variable M), the printing control means 20 references the management table storage means 40, and selects printing data in the order of the oldest time of storage (S106).

Next, the printing control means 20 references the management table storage means 40 and judges whether the deletion priority information for the above selected printing data is priority level 1 (S107).

If the deletion priority information of the above selected printing data is other than priority level 1, the above selected printing data is not deleted, and processing proceeds to S112.

If on the other hand the deletion priority information of the above selected printing data is priority level 1, the printing control means 20 references the management table storage means 40, reads out the data size of the above selected printing data (S108), and updates the variable M according to “variable M=variable M−(data size of above readout data)” (S109).

Then, the printing control means 20 deletes the above selected printing data from the printing data storage means 30, and in addition deletes the information relating to the above selected printing data from the management table storage means 40 (S110). At this time, a configuration may be adopted in which the client device which had transmitted the printing data is notified of the deletion of the printing data.

Next, the printing control means 20 judges whether (variable M>0) obtains (S111), and if judged to obtain, the printing data with the next-oldest storage time after the above selected printing data is selected, and processing returns to S107 (S112).

On the other hand, if the above condition is judged not to obtain, the printing control means 20 stores the above received printing data in the printing data storage means 30 (S113).

New management information is generated for the above received printing data so as not to overlap with previously generated management information (S114), and this newly generated management information is registered in the management table storage means 40 in association with the storage address, data size, storage time (for example, the date and time of execution of S115), deletion priority information (as an initial value, for example, priority level 1) for the above received printing data (S115).

Next, the printing control means 20 transmits the above generated management information to the client device which in S100 had transmitted the printing request (S116).

By this means, the client device can receive management information associated with the transmitted printing data. In this aspect, a configuration is adopted in which the client device stores the printing data associated with the management information, and when transmitting a printing request of the second type, inserts the corresponding management information into the printing request for transmission.

The printing control means 20, upon completing data management processing (S104 to S116), proceeds to S120.

On the other hand, in the judgment of S101, when the printing request is judged to be of the second type, the printing control means 20 extracts the management information from the printing request (S117).

Next, the printing control means 20 references the management table storage means 40 and reads out the storage address associated with the above extracted management information (S118), references the printing data storage means 30 and reads out the corresponding printing data based on the above read-out storage address (S119), and proceeds to S120. A configuration may be employed in which, when the above extracted management information has previously been deleted from the management table storage means 40 (when the printing data has been deleted from the printing data storage means 30), it is necessary to have the client device retransmit the printing data, and so processing proceeds to S102.

The printing control means 20 executes printing control processing based on the printing data received in S103 or on the printing data read out in S118 (S120). For example, when the printing data is JPEG format compressed image data, decompression processing is executed to restore the image data, and after executing size conversion processing, color conversion processing, error diffusion dithering and other operations as necessary, the image data is transferred to the printing engine 11, which is caused to perform printing.

Next, the printing control means 20 references the rule storage means 50, and based on applicable registered setting rules, updates the deletion priority information stored in the management table storage means 40 (S121). Below, a method of updating based on a specific example is explained.

When for example the setting rule “the priority level for printing data which is printed consecutively 2 or more times is set low” is registered as an applicable rule, the printing control means 20 judges whether management information for printing data processed in the previous printing control processing coincides with the management information for the printing data currently subjected to printing control processing (the printing data read out in S119), and if the two coincide, sets the priority level associated with the printing data one level lower (when the priority level is already 3, no action is performed).

Also, when for example the setting rule “the priority level is set low for printing data the size of which is 2 megabytes or greater” is registered as an applicable rule, the printing control means 20 judges whether the data size of the printing data currently subjected to printing control processing (the printing data received in S103) is 2 megabytes or greater, and if the size is 2 megabytes or greater, sets the priority level associated with the printing data to 2 or to 3 (because the priority level of the printing data received in S103 has an initial value of 1).

In this way, in this aspect a configuration is adopted in which management information is stored in association with received printing data in the printer 1, and when a printing request based on management information is received from a client device, the printing data corresponding to the management information is read out and printing is executed. Consequently when printing printing data stored in the printer 1, there is no need for the client device to transmit the printing data. As a result, the power consumption involved in transmission of printing data is eliminated, and the time of operation of a rechargeable device can be extended, while the time required for data transmission can be shortened and printing can be executed efficiently.

When deleting printing data stored in the printer 1, printing data the probability of printing of which is expected to be low based on prescribed rules, and printing data the retransmission of which would not have a great impact on printing throughput, are given priority for deletion; hence the frequency of occurrence of retransmission can be reduced, and even when retransmission is necessary the lowering of printing throughput can be suppressed, and printing processing can be executed efficiently.

### MODIFIED EXAMPLE

This invention is not limited to the above aspect, and various modifications are possible.

For example, in the above aspect a configuration is employed in which the data for deletion is selected based on deletion priority information; but the time of storage, time of use, frequency of use, data size, and other parameters can themselves be regarded as priority information related to data deletion, and a configuration adopted in which data for deletion is selected based directly on these parameters. As such an example, a configuration is conceivable in which data is deleted in the order of the oldest storage time.

Also, in the above aspect a configuration is employed in which printing is always executed based on printing data after the printing data is received and stored, but such a configuration need not be adopted; for example, a configuration is possible in which, after printing data is received and stored, printing is not performed until an execution instruction is received.

Also, in the above aspect a configuration is adopted in which transmission and reception of printing data is performed by means of three steps, which are 1) transmission of a printing request of the first type to the printer 1 by a client device, 2) transmission of a printing data transmission request to the client device by the printer 1, and 3) transmission of the printing data to the printer 1 by the client device, whereas transmission and reception of management information is performed by means of a single step, which is 1) transmission of a printing request (including management information) to the printer 1 by the client device; however, this invention is not limited to such a configuration. For example, a configuration may also be adopted in which the transmission and reception of printing data is performed by means of a single step, or in which the transmission and reception of management information is performed by means of three steps.

Also, in the above aspect a configuration is employed in which a judgment as to whether printing data will be deleted is made based on the result of a comparison of the data size of newly received printing data, and the free space of the printing data storage means 30; but in place of or together with this configuration, a configuration may also be employed in which this judgment is made based on the result of comparison of, for example, the free space with a prescribed threshold value, regardless of the time of reception of printing data.

Also, in the above aspect a configuration is employed in which, in S106 and S112, printing data is selected in the order of the oldest time of storage; but a configuration may be employed in which printing data is selected according to, for example, the lowest frequency of use, the oldest time of use, the smallest data size, or according to some other order.

Also, in the above aspect a configuration, when for example there is no printing data selected in S112 (sufficient free space cannot be secured by deleting only printing data with priority level 1), the judgment level in S107 may be lowered by one level, that is, making the modification “judge whether the deletion priority information of the previously selected printing data is priority level 2,” and data management processing may then be re-executed. Further, in cases where no printing data is selected in S112 even when such a modification is made, deletion may for example be performed in the order of the oldest time of storage.

Also, a configuration may be employed in which the printing data, management table, setting rules and similar are managed for each individual client device by the printing data storage means 30, management table storage means 40 and rule storage means 50. For example, in cases where wireless communication with a client device is performed based on the Bluetooth standard, a Bluetooth ID may be used to manage printing data and similar individually for each client device.

Finally, this invention can be applied not only to equipment generally referred to as printers, such as for example inkjet printers or label printers, but also to various other information processing equipment (photocopy equipment, fax equipment, handy terminals, and similar) comprising functions for formation of images based on data received from a client device.

The entire disclosure of Japanese Patent Application No. 2002-363109, filed on Dec. 13, 2002, including the specification, claims, drawings and summary, are incorporated herein by reference in its entirety.

1. A printing control method, comprising:
a data management step of storing printing data received from a client device, in storage means in association with management information, and of transmitting said management information to said client device when a printing request received from the client device is a printing request of the type involving the transmission and reception of printing data;
a step of referencing said storage means and of reading out printing data associated with management information received from said client device when said printing request is of the type involving the transmission and reception of management information associated with the printing data in the data management step; and,
a step of executing printing, based on said received printing data or on said read-out printing data.

2. The printing control method according to claim 1, wherein said data management step, when judging it necessary to delete printing data from said storage means, selects and deletes printing data based on priority information relating to data deletion.

3. The printing control method according to claim 2, wherein said data management step references rule storage means which stores at least one setting rule for said priority information, and sets said priority information.

4. The printing control method according to claim 3, further comprising a step of registering setting rules in said rule storage means based on input from a user.

5. The printing control method according to claim 3 or claim 4, wherein said setting rules are composed based on at least one among the time of storage, time of use, frequency of use, and data size of the printing data.

6. A printing system, comprising:
data management means for storing printing data received from a client device in storage means in association with management information, and for transmitting management information to said client device when a printing request received from the client device is a printing request of the type involving the transmission and reception of printing data;
means for referencing said storage means and for reading out printing data associated with management information received from said client device when said printing request is of the type involving the transmission and reception of management information associated with the printing data by the data managem00ent means; and,
means for executing printing, based on said received printing data or on said read-out printing data.

7. A printing system, comprising at least one client device and a printing device configured to enable communication with said client device, wherein said client device can output two types of printing requests, consisting of a first type involving the transmission and reception of printing data and a second type involving the transmission and reception of management information associated with printing data by the printing device, and wherein
said printing device, upon receiving the first type of printing request from a client device, stores printing data received from said client device in association with management information in storage means, transmits said management information to said client device, and executes printing based on said printing data; whereas,
upon receiving the second type of printing request from a client device, references said storage means, reads out printing data associated with management information received from said client device, and executes printing based on said read-out printing data.
